(19) United States
(12) Patent Application Publication
(10) Pub. No.: US 2008/0159383 A1
(43) Pub. Date: Jul. 3, 2008

(54) Tagboard for video tagging

(75) Inventors: Mayank Kukreja, Uttar Pradesh (IN); Srinivasan H. Sengamedu, Bangalore (IN)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc.

(21) Appl. No.: 11/717,507

(22) Filed: Mar. 12, 2007

(30) Foreign Application Priority Data
Dec. 27, 2006 (IN) 2811/DELNP/2006

(51) Int. Cl. H04N 11/02

(52) U.S. Cl. 375/240.01

(57) ABSTRACT

Keyframes of video are arranged on a display based on characteristics on the keyframes, such as content similarity and temporal relation as compared to each other, where input is received comprising one or more keyframes from video data and it is determined where to display the one or more keyframes along a first axis of the display based on a time associated with the keyframe or keyframes. It is determined where to display the one or more keyframes along a second axis based on the content of the keyframe or keyframes.

### RELATED APPLICATION DATA

This application is related to and claims the benefit of priority from Indian Patent Application No. 2811/DELNP/2006, entitled “Tagboard for Video Tagging,” filed Dec. 27, 2006 (Attorney Docket Number 50269-0850), the entire disclosure of which is incorporated by reference as if fully set forth herein.

This application is related to U.S. patent application Ser. No. 11/637,422, entitled “Automatically Generating A Content-Based Quality Metric For Digital Images,” (Attorney Docket Number 50269-0830) the named inventors being Ruofei Zhang, Ramesh R. Sarukkai, and Subodh Shakya, filed Dec. 11, 2006, the entire disclosure of which is incorporated by reference as if fully set forth herein.

### FIELD OF THE INVENTION

The present invention relates to digital video and, more specifically, to spatially displaying portions of digital video according to temporal proximity and image similarity.

### BACKGROUND

There is an explosion of media content on the Internet. Much of this content is user-generated, and while most of the content is image data, an increasing amount is in the form of video data, such as digital movies taken by a digital camcorder and uploaded for public access. The vastness of the available data makes searching for specific videos or portions of videos difficult.

One approach to facilitating search of this media content is the use of tags. Tags are labels, usually provided by a user, which provide semantic information about the associated file. Tags may be used with any form of media content, and may be human-generated, or automatically generated from a filename, by automated image recognition, or other techniques. Tags are a valuable way of associating metadata with images. An example of using tags to facilitate search is by using tags, a user may search for “fireworks,” and all images with an associated “fireworks” tag are returned.

Tags may be associated with media files by users other than the creator, if they have the appropriate permissions. This collaborative, wide collection of tags is known as folksonomy, and promotes the formation of social networks. Video organization and search can benefit from tagging; however, unlike images, videos have a temporal aspect and large storage and bandwidth demands. Hence the ease of tagging associated with digital images is diminished with video content.

One approach to associating tags with digital video data is for a user to watch a video from start to finish, pausing at various points to add tags. This approach generally leads to multiple viewings of the video, because starting and stopping a video to add tags diminishes the experience of watching a video for the first time due to its temporal nature. Also, the media player used to view the video needs to support tagging. For videos available on the Internet, users are unlikely to download the entire video just for the sake of tagging because of the size and bandwidth constraints.

Another approach to associating tags with video data is to present the user with selected frames from the video and allow these to be tagged. For example, for a 5-minute video file, one frame may be chosen every 30 seconds, for a total of 10 frames. These 10 frames may be presented for tagging in a slideshow or collectively. A disadvantage to this technique is that a video might cover multiple events in an interleaved fashion. A random sampling of frames may not include frames of each event. Further, to best tag an event, a user needs to compare several frames far apart to choose the best frame to tag. Also, many scenes may be similar, such as different groups of people talking to each other. This approach to tagging places a high cognitive burden on the user to differentiate between similar scenes.

Therefore, an approach for displaying portions of video data for tagging, which does not experience the disadvantages of the above approaches, is desirable. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a system according to an embodiment of the invention;

FIG. 2 is a block diagram illustrating a strand representation of keyframes on a tagboard;

FIG. 3 is a is a block diagram illustrating a collage representation of keyframes on a tagboard;

FIG. 4 is a flowchart illustrating the functional steps of causing to be displayed a tagboard according to an embodiment of the invention; and

FIG. 5 is a block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Functional Overview

Techniques are discussed herein for representing keyframes of video on a display based on characteristics on the keyframes, such as content similarity and temporal relation as compared to each other.

According to an embodiment, input is received comprising one or more keyframes from video data and it is determined where to display the one or more keyframes along a first axis of the display based on a time associated with the keyframe or keyframes. The time may be an absolute value compared to another absolute value, or may be a relative comparison of placement of a keyframe in a video. It is then determined where to display the one or more keyframes along a second axis based on the content of the keyframe or keyframes.

According to an embodiment, video data is segmented into two or more shots, and at least one keyframe is generated from each shot. Then, a temporal relation between each keyframe is automatically determined and an image similarity relation between each keyframe is determined based on the content of the keyframes. This image similarity relation may be determined based on a numeric value assigned to each keyframe that describes aspects of the keyframe such as content, color, motion, and/or the presence of faces. Then the keyframes are automatically caused to be displayed on a display relative to each other along one axis based on the temporal relation and along a second axis based on the image similarity relation. According to an embodiment, the keyframes may be displayed along a third axis.

### Architectural Overview

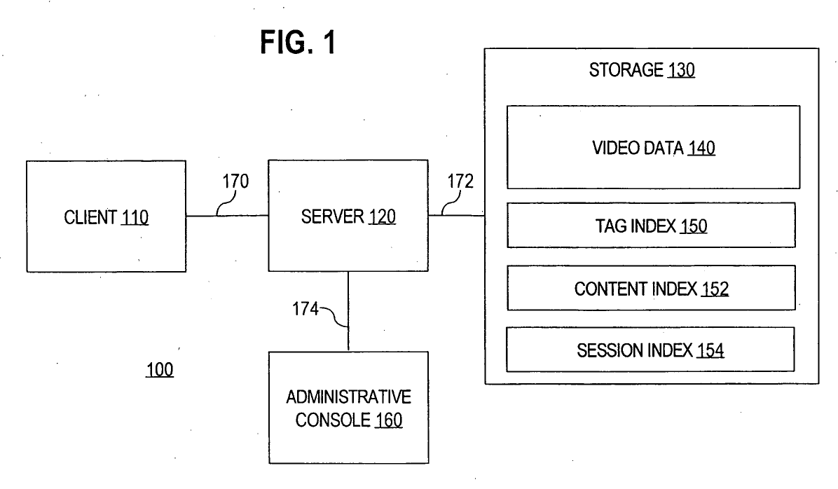

FIG. 1 is a block diagram of a system 100 according to an embodiment of the invention. Embodiments of system 100 may be used to display portions of video data to a user and receive data such as tags to associate with the portion of video data. A user may specify a video to display using the techniques described herein, receive video data or portions of video data such as digital images, view the data and provide input to be associated with the video data, such as tags.

In the embodiment depicted in FIG. 1, system 100 includes client 110, server 120, storage 130, video data 140, tag index 150, a content index 152, a session index 154, and an administrative console 160. While client 110, server 120, storage 130, and administrative console 160 are each depicted in FIG. 1 as separate entities, in other embodiments of the invention, two or more of client 110, server 120, storage 130, and administrative console 160 may be implemented on the same computer system. Also, other embodiments of the invention (not depicted in FIG. 1), may lack one or more components depicted in FIG. 1, e.g., certain embodiments may not have a administrative console 160, may lack a session index 154, or may combine one or more of the tag index 150, the content index 152, and the session index 154 into a single index.

Client 110 may be implemented by any medium or mechanism that provides for sending request data, over communications link 170, to server 120. Request data specifies a request for one or more requested portions of video data. This request data may be in the form of a user selecting a file from a list or by clicking on a link or thumbnail image leading to the file. It may also comprise videos that satisfy a set of search criteria. For example, request data may specify a request for one or more requested videos that are each (a) associated with one or more keywords, and (b) are similar to that of the base video referenced in the request data. The request data may specify a request to retrieve one or more videos within the plurality of videos 140, stored in or accessible to storage 130, which each satisfy a set of search criteria. The server, after processing the request data, will transmit to client 110 response data that identifies the one or more requested video data files. In this way, a user may use client 110 to retrieve digital video data that matches search criteria specified by the user. While only one client 110 is depicted in FIG. 1, other embodiments may employ two or more clients 110, each operationally connected to server 120 via communications link 170, in system 100. Non-limiting, illustrative examples of client 110 include a web browser, a wireless device, a cell phone, a personal computer, a personal digital assistant (PDA), and a software application.

Server 120 may be implemented by any medium or mechanism that provides for receiving request data from client 110, processing the request data, and transmitting response data that identifies the one or more requested images to client 110.

Storage 130 may be implemented by any medium or mechanism that provides for storing data. Non-limiting, illustrative examples of storage 130 include volatile memory, non-volatile memory, a database, a database management system (DBMS), a file server, flash memory, and a hard disk drive (HDD). In the embodiment depicted in FIG. 1, storage 130 stores the plurality of videos 140, tag index 150, content index 152, and session index 154. In other embodiments (not depicted in FIG. 1), the plurality of videos 140, tag index 150, content index 152, and session index 154 may be stored across two or more separate locations, such as two or more storages 130.

Plurality of videos 140 represent video data that the client 110 may request to view or obtain. Tag index 150 is an index that may be used to determine which digital videos or portions of videos, of a plurality of digital videos, are associated with a particular tag. Content index 152 is an index that may be used to determine which digital videos or portion of video, of a plurality of digital videos, are similar to that of a base image. A base image, identified in the request data, may or may not be a member of the plurality of videos 140. Session index 154 is an index that may be used to determine which digital videos, of a plurality of digital videos, were viewed together with the base video by users in a single session.

Administrative console 160 may be implemented by any medium or mechanism for performing administrative activities in system 100. For example, in an embodiment, administrative console 160 presents an interface to an administrator, which the administrator may use to add digital videos to the plurality of videos 140, remove digital videos from the plurality of videos 140, create an index (such as tag index 150, content index 152, or session index 154) on storage 130, or configure the operation of server 120.

Communications link 170 may be implemented by any medium or mechanism that provides for the exchange of data between client 110 and server 120. Communications link 172 may be implemented by any medium or mechanism that provides for the exchange of data between server 120 and storage 130. Communications link 174 may be implemented by any medium or mechanism that provides for the exchange of data between administrative console 160, server 120, and storage 130. Examples of communications links 170, 172, and 174 include, without limitation, a network such as a Local Area Network (LAN), Wide Area Network (WAN), Ethernet or the Internet, or one or more terrestrial, satellite or wireless links

### Shot Segmentation

A “shot” is defined as an uninterrupted segment of video data. For example, a video may be comprised of one or more shots. A video may have an uninterrupted segment of footage of a birthday party and a subsequent uninterrupted segment of footage of a fireworks display. Each of these are shots. If the segments are interleaved throughout the video at different positions, each interleaved segment of either the birthday party or fireworks display would be a shot.

Changes from one shot to another may be abrupt or gradual. An abrupt shot change is herein referred to as “cut.” An example of a gradual change may be wherein a dissolve effect is used to transition between shots, or where the camera is slowly panned from one scene to another, each scene comprising a shot.

Detecting shot changes may be determined using a variety of methods known in the art. For example, techniques exist for shot boundary detection based on color, edge, motion and other features. While these techniques are effective at detecting cuts, gradual shot changes present a challenge because of advances in video editing techniques that allow for incorporation of newer and more complex effects in video.

One approach for detecting gradual shot changes is a twin threshold technique suggested by H. J. Zhang, A. Kankanhalli and S. W. Smoliar in “Automatic partitioning of full-motion video,” Multimedia Systems, 1993. While this is one approach, taking a pair-wise frame difference is sensitive to camera motion. The method for shot segmentation should be such that it is resistant to camera or object motion and sensitive to gradual scene change. Approaches for achieving the prior goals include multi-step comparison approaches that take accumulated frame differences over a sliding window into account rather than pair-wise frame difference.

According to an embodiment, shot boundary detection may be accomplished using accumulated luminosity histogram difference to detect shot changes. The distance map δ is defined as:

$$δ ( n . l ) = \frac{100}{2 WH} {\sum }_{i = 0}^{M - 1} \vert h ( n - l , i ) - h ( n + l , i ) \vert$$

where h(n+l, i) and h(n+1+l, i) denote the histograms of frames n+l and n+1+l, respectively, δ(n, l) denotes the histogram difference between h(n+l, i) and h(n+1+l, i), and W and H denote the width and height of frame, respectively. The metric delta is then normalized by subtracting the mean of sliding window from δ of each frame. Further, doing a summation of resulting metric over the sliding window and applying a suitable threshold gives shot boundaries.

### Keyframe Extraction and Selection

A “keyframe” of a video segment is defined as a representative frame of the entire segment. Keyframe selection techniques vary from approaches of selecting the first, middle, or last frame to very complex content and motion analysis methods. Selecting the first, or middle, or last keyframe is not highly efficient in this context as it may not be representative of the content in the shot if there is high motion within the shot.

The maxima of accumulated normalized differences gives the shot boundary and the minima within that shot provides the keyframe. A goal of the approach is to select the keyframe which is “interesting” as well as “representative” of content. A difficulty arises in defining “interesting” in view of keyframe detection. According to an embodiment, keyframe selection is integrated with shot boundary detection. What it means for a keyframe to be “interesting” as well as “representative” may vary from implementation to implementation.

After selecting the keyframe for each shot, according to an embodiment, the selected keyframes are ranked. Keyframes considered “interesting” should be ranked higher. According to an embodiment, an “interesting” keyframe has faces in it so as to indicate who the people present in the shot are. Also, an interesting keyframe should not be monochromatic. A wider spread of colors within a frame indicates richer content. According to an embodiment, for each frame in the shot, measures of (1) color content (2) motion in the frame (3) presence and size of faces, among other factors, are calculated. A representative frame (or keyframe) of the shot is the frame which has rich colors, high degrees of motion, and potentially contains faces. If p_{c}(f), pₘ(f), and p_{f}(f) are measures (1)-(3) for a frame then the frame f₁ for which p_{c}(f)×pₘ(f)×p_{f}(f) is maximum.

Based upon the above considerations, an embodiment uses a weighted sum of faces present in the frame and color histogram entropy to rank the keyframes. Other considerations may be quantified and included in the determination. In addition to being “representative” and “interesting,” highly ranked keyframes should be visually distinct from each other. For example, if two different shots are taken just from different camera angles, their keyframes will also be quite similar. In such a case, both keyframes should not be ranked highly. According to an embodiment, color histogram difference may be used to ensure that high ranked keyframes are different from each other.

### Video Presentation and Tagging

Embodiments of the invention employing the above techniques may be used to display keyframes of video based on image similarity and dimensionality reduction in a manner that facilitates tagging. According to an embodiment, keyframes are clustered to aid in identification and tagging of keyframes. The human visual perception for identifying clusters is exploited by the described techniques and the high-dimensional image data is projected to lower dimensional space, typically 1 or 2 dimensions, to provide users with a better sense about the organization of data, in this case keyframes. This organization is interpreted, and may be corrected, by users. According to an embodiment, keyframes are represented using features such as color, motion, presence of faces, among others. As the feature space is high-dimensional (typically, a few hundred dimensional), for visualization purposes, these features have to be projected to one, two, or three dimensions. If one dimension is reserved for capturing temporal proximity, then there exist at most two dimensions for capturing image similarity.

According to an embodiment, a temporal relation is calculated between keyframes. For example, time data may be associated with each keyframe and this time data is compared to determine the temporal relation of one keyframes to another, as in whether one keyframe is from earlier in the video data than another or whether one keyframe was taken earlier in time than another keyframe from the same video data or different video data. This temporal relation may be ascertained by comparing timestamp data, for example.

According to an embodiment, a similarity relation is determined between keyframes. The similarity of the content between two or more keyframes may be evaluated based upon an image similarity relation between keyframes as determined based upon the content of each keyframe, wherein the content is determined based upon techniques described herein. Keyframes with a higher image similarity relation have content that is more similar. According to an embodiment, the image similarity relation may be determined by comparing numerical values assigned to each keyframe that describe the content of the keyframe.

According to an embodiment, keyframe images may be described by a combination of color and textual features. The color features are color histograms and texture description may be based on gradient orientation histograms. Other features capable of being utilized are MPEG-7 color and texture features.

For visualization, these features are projected into low dimensional space. According to an embodiment, this dimensionality reduction is achieved using the Locally Linear Embedding algorithm. The LLE algorithm is a fast dimensionality reduction algorithm that identifies local geometry in high dimensional space, and produces a projection to low dimensional space which preserves the original local geometry. LLE captures the local geometry of high-dimensional features using a set of weights obtained using a least squares technique. These weights are used for obtaining coordinates in the reduced dimensional space. The technique is locally linear but globally non-linear. According to an embodiment, one dimension is used for time because of video's strong temporal aspect. The other dimension may be used for depicting keyframe similarity. Using LLE, the image features, corresponding to keyframes, are projected into ID space. The frame number is used as the other axis. Keyframe images are placed in a 2D canvas according to the coordinate positions thus derived. This 2D canvas is called the tagboard.

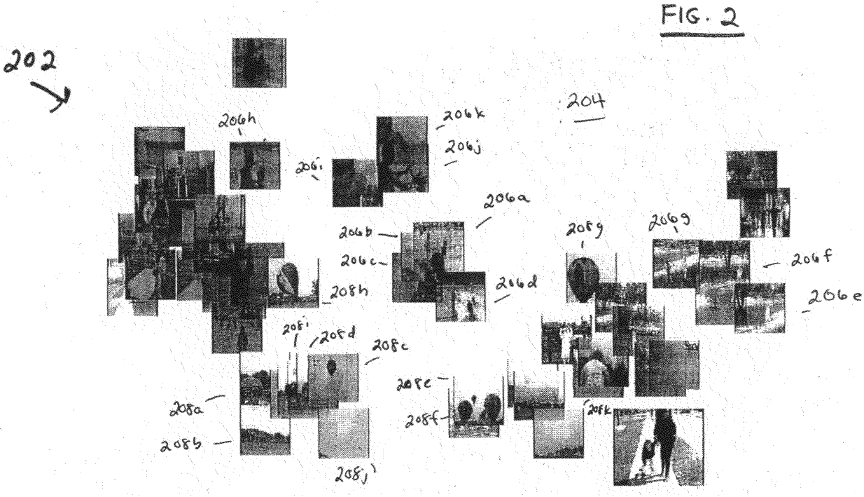

FIG. 2 illustrates an example representation of keyframes 202 on a tagboard 204 called a “strand” representation. In FIG. 2, the X-axis denotes time and the Y-axis is a measure of image content. Similar images have small distances along the Y-dimension. The keyframes in this example are divided between keyframes from a “swimming pool” and “balloon” event that were recorded during the same video recording session and exist in the same video file. The video may consist of 2 shots, one of the swimming pool event, and one of the balloon event, or may consist of multiple shots of each event interleaved amongst each other.

In. FIG. 2, keyframes corresponding to the swimming pool event 20a-206k are close together and are separated from those of the balloon event 208a-208k. The horizontal axis captures information about temporal relation of the two events in the video.

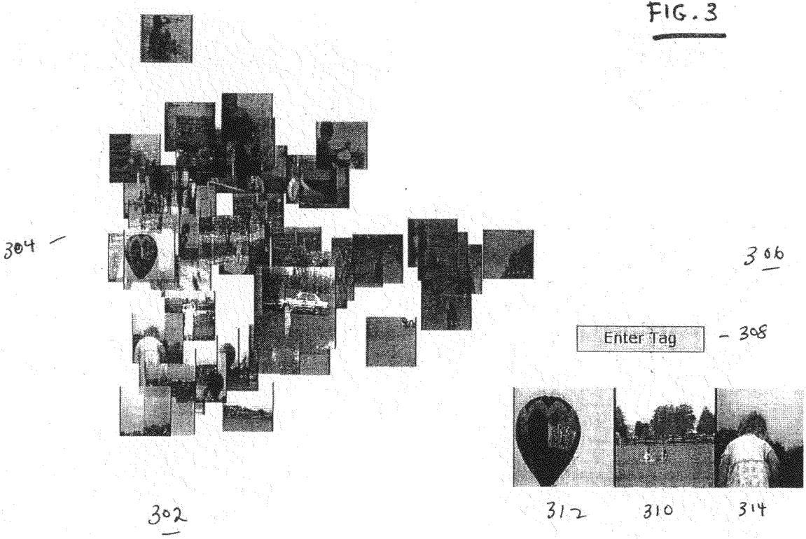

According to an embodiment, the temporal relation of keyframes may be ignored and the keyframe features projected into two dimensions. This is called a “collage” representation and is illustrated in FIG. 3. The collage representation captures scene similarity without regard for temporal ordering, which is useful in visualization of long videos.

One embodiment of the approach for organizing keyframes on the tagboard begins with performing a shot segmentation on a video, as described earlier, performing a keyframe selection, into the N best keyframes, using the above described techniques. Then, let f₁, f₂, . . ., f_{M} be the keyframes and t₁, t₂, . . . , t_{M} be the frame numbers of the keyframes. Let fᵢₗ, fᵢ₂, . . . , f_{iN} be the subset of the N best keyframes.

For each keyframe f₁ᵢ, i=1 . . . M, calculate color and texture feature vectors. The texture features used can be, for example, gradient orientation histograms or Gabor features. Let F be the M×L feature matrix where L is the number of features. Then, use the LLE algorithm, or an algorithm with similar functionality, to project F to one or two dimensional subspace. Let F′ be the one-dimensional projection and F″ be the two-dimensional projection. F′ is M×1 (a vector) and F″ is M×2. Let the tagboard size be P×Q where P is the width and Q is the height.

For one embodiment of a Strand tagboard, affinely transform the elements of L′ to [0, Q] using translation and scaling. These numbers provide the vertical coordinates on the tagboard. Then, transform t₁, . . . , t_{N} to [0, P] by scaling. Those numbers provide the horizontal coordinates on the tagboard. Then, the first column of L″ is affinely transformed to [0, P] and the second to [0, Q]. These numbers serve as new coordinates on the tagboard.

For Strand and Collage embodiments, among others, keyframes f₁, . . . , f_{M} are placed on the tagboard according to the derived coordinates. Keyframes fᵢₗ, . . . , f_{N} are kept on the top. Remaining keyframes are placed below. According to an embodiment, the best keyframes are always shown at the top. According to an embodiment, all keyframes have a transparency factor. This factor is within a range that allows keyframes stacked beneath other keyframes to be at least partially visible.

In FIG. 3, the left part of the tagboard 302 contains the collage 304 and the bottom right illustrates one embodiment of a tagging interface 306. The tagging interface 306 may be used in either the strand or collage tagboard or any other representation of keyframes. An input field 308 may be used to enter tags about a keyframe. According to an embodiment, input may be received from a user, such as from a mouse, keyboard or tablet, such that if a user moves a cursor associated with the input device over a keyframe, the keyframe is enlarged and brought to the top of the tagboard so that it is visible over overlapping and nearby keyframes. This allows a user to examine the keyframe in detail. User input may be received to further enlarge the keyframe or move other keyframes in proximity to the selected keyframe temporarily out of the way so that the selected keyframe may be viewed without distraction.

According to an embodiment, user input is received selecting the chosen keyframe, such as a user clicking on the chosen keyframe using a mouse. Upon this selection, the keyframe 310 is displayed in the tagging interface 306 separately along with the previous 312 and next 314 keyframes. A tag input area 316 is activated enabling a user to input tags related to the corresponding shot. These tags are associated with the corresponding shot as described earlier. According to an embodiment, if the user clicks on a keyframe displayed in the tagging area, the underlying video begins playing starting from the shot corresponding to the keyframe. Keyframes on the tagboard with associated tags may be displayed with a red border or displayed in a manner differentiating their status as having associated tags from those keyframes not being tagged. For example, non-tagged keyframes may be displayed with a blue border, or no border. Tagged keyframes may have their transparency value set to a different level than those without tags.

For some events, multiple clips may exist. In this case, some clips may be tagged while other may not be. According to an embodiment, tags may be propagated from the tagged clips to the untagged clips by displaying the clips on the same tagboard. Since similar keyframes would be close together, tags may be “dragged and dropped” from one video clip to another. For example, a user would see that one keyframe has tags while another, similar keyframe does not. This may result from displaying tagged keyframes with a colored border as described earlier. A user may click on a tagged keyframe, thereby bring up the keyframe and its associated tags in the tagging interface 306. Tags associated with the chosen keyframe may be displayed in the tagging interface 306 and dragged and dropped on a similar keyframe without associated tags.

In situations where multiple clips exist, it may be difficult for a user to identify differences in content. For example, an event may be captured by multiple video recorders, and a user may desire to identify similar scenes. By displaying the multiple videos according to the techniques described herein, similar scenes will have common keyframes displayed in proximity to one another. Techniques may be used to identify the source of keyframes, such as color or labels. In this manner, a user will be able to quickly identify which sources contain similar scenes and the videos may thus be aligned.

According to an alternate embodiment, one dimension of the tagboard display may be used for temporal proximity and two for image similarity, thereby expanding the tagboard into three dimensions. The above embodiments use image transparency to provide a form of depth perception and three dimensions. A full utilization of three dimensions would provide a clearer view of overlapping image similarity. Alternatively, each of the three dimensions of the tagboard may be used for any type of display based on any criteria.

According to an embodiment, the density of keyframes represented on the tagboard is unlimited. Where numerous keyframes are displayed, this density may become confusing, so the density of keyframes may be limited and keyframes identified as less significant may be dropped from the tagboard in dense regions.

Because videos are about events and people who participate in them, keyframe tagging can be used for tagging people and events which predominantly occur in a single shot. If an event occurs over multiple but non-contiguous shots, a linear representation makes it difficult to tag the shot. Because of the clustering effect and display herein described, it is possible to capture and tag such events much more easily and intuitively.

### Tagboard Implementation

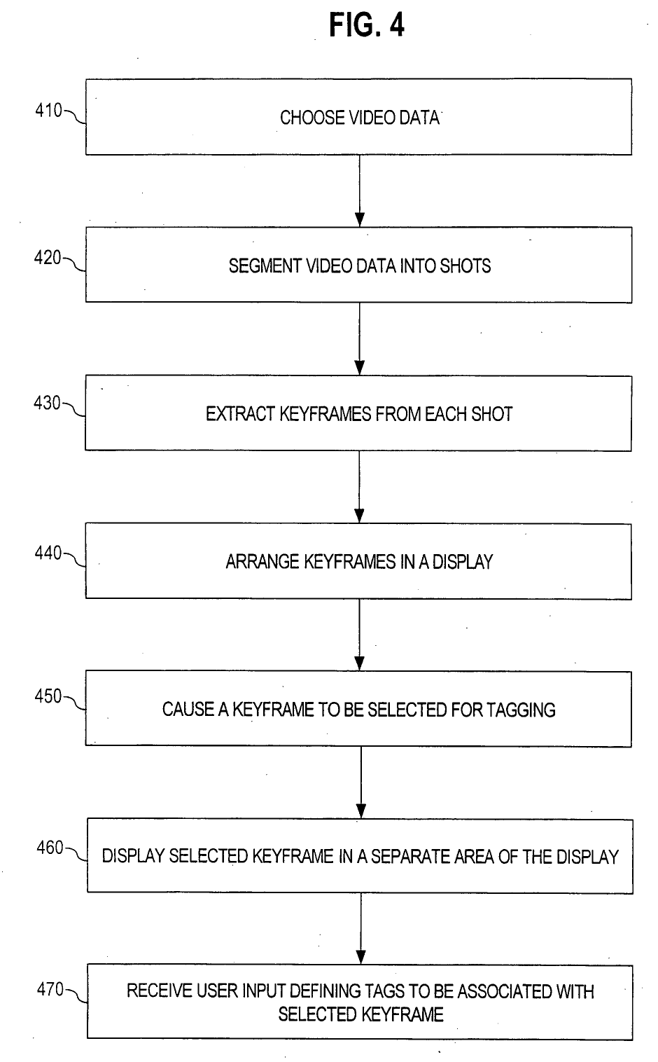

FIG. 4 is a flowchart 400 illustrating the functional steps of causing to be displayed a tagboard according to an embodiment of the invention. The particular sequence of steps illustrated in FIG. 4 is merely illustrative for purposes of providing a clear explanation. Other embodiments of the invention may perform various steps of FIG. 4 in parallel or in a different order than that depicted in FIG. 4.

Initially, in step 410, video data is chosen upon which to perform the above-described techniques. For example, a user may have just uploaded a video file to a website, or a user may select a video on the Internet to view and tag according to the techniques described herein.

In step 420, the selected video data is segmented into shots as described earlier. This process may be fully automated or may proceed with a degree of human interaction. For example, a proposed shot segmentation may be presented to the user, and the user may accept the proposed segmentation or adjust various aspects through a user interface. This level of human interaction would provide a way of dividing between scenes with certainty; for example, a gradual scene dissolve may be identified by a user and divided at a point acceptable to the user.

In step 430, keyframes are extracted from each shot according to the techniques described earlier. For each shot, the number of keyframes may be limited to a certain number. The number of keyframes may be limited to only those deemed “interesting” and/or “representative” according to the techniques described earlier. The number of keyframes may be specified by the user in the form of a single number or a range.

In step 440, the keyframes are arranged in a display according to the techniques described earlier. The horizontal dimension represents temporal proximity (keyframes close together in time) while the vertical dimension depicts keyframe similarity (color, texture, content). The temporal relation between keyframes is determined and the image similarity relation between keyframes is determined. This allows the keyframes to be compared based on a time associated with each keyframe and the content of each keyframe. According to an embodiment, the time and similarity comparisons may be made based upon a relative determination between each keyframe. Coordinates of the keyframes on the tagboard, as well as the tagboard size, are determined according to the techniques described earlier. The keyframes may be projected into one-, two-, or three-dimensions according to the techniques described earlier. According to an embodiment, the “best” keyframes are displayed near the top of the tagboard, while overlapping keyframes are visualized with a level of transparency. 100611 In step 450, a user identifies a keyframe for tagging. For example, a user wants to tag all shots where a home run is hit, or candles on a birthday cake are extinguished. According to an embodiment, the user moves a cursor over various keyframes that appear to correspond to the event in question. Because similar keyframes are in proximity, this procedure is simplified. Keyframes underneath the cursor may “jump” out of the tagboard for easier inspection to create easier identification. This may be accomplished by zooming the display in on the keyframe or moving overlapping and nearby keyframes out of the way to provide an unimpeded view of the keyframe under the cursor.

Once the user has identified a keyframe to tag, in step 460 the user clicks on the keyframe and the selected keyframe is displayed in the tagging interface, or in a separate window, or in some manner that separates the keyframe from the tagboard display. According to an embodiment, the selected keyframe is displayed along with the immediately preceding keyframe and immediately following keyframe. The number of preceding and following keyframes may be adjusted.

In step 470, after a tag is selected and displayed in the tagging interface, a text box or similar input element is provided for the user to enter tags. For example, a user may have selected a keyframe corresponding to a shot of a home run. The user could tag the keyframe with “home run,” the date of the game, the name of the player hitting the home run, and any text that a user desires. The number of tags a user may associate with a keyframe my be artificially limited with a preference setting or only limited by storage and database restrictions.

### Implementing Mechanisms

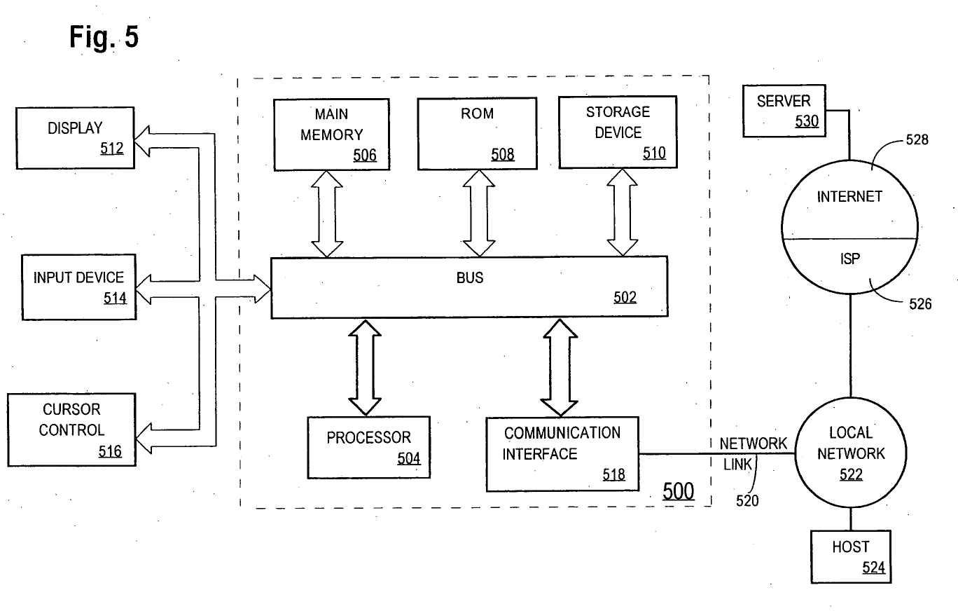

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 500, various machine-readable media are involved, for example, in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for displaying images from video data, the computer-implemented method comprising the steps of:
receiving input comprising a keyframe from video data;
determining where to display the keyframe along a first axis based on a time associated with the keyframe; and
determining where to display the keyframe along a second axis based on the content of the keyframe.

2. The computer-implemented method of claim 1 further comprising:
receiving user input selecting the keyframe;
receiving user input comprising at least one tag;
creating data associating the at least one tag with the selected keyframe; and
storing the data.

3. The computer-implemented method of claim 2 wherein:
the step of receiving user input selecting a keyframe includes:
automatically displaying the selected keyframe in a clear portion of the display;
automatically determining a keyframe from the video data immediately preceding the selected keyframe and a keyframe from the video data immediately following the selected keyframe; and
displaying the immediately preceding keyframe and the immediately following keyframe adjacent to the selected keyframe.

4. The computer-implemented method of claim 3 further comprising:
receiving user input selecting the selected keyframe;
in response to the user input, causing the video data to be played beginning from the frame associated with the selected keyframe.

5. The computer-implemented method of claim 2 wherein the step of creating data associating the at least one tag with the selected keyframe includes receiving user input comprising dragging a tag and dropping the tag into a specified area of the display.

6. The computer-implemented method of claim 1 wherein the keyframe comprises a first keyframe and further comprising:
receiving input comprising a second keyframe from the video data;
automatically determining an image similarity relation between the content of the first keyframe and the content of the second keyframe; and
determining where to display the first keyframe and second keyframe relative to each other along the second axis based on the image similarity relation.

7. The computer-implemented method of claim 1 wherein the keyframe comprises a first keyframe, the video data comprises a first video data, and further comprising:
receiving input comprising a second keyframe from a second video data;
automatically determining an image similarity relation between the content of the first keyframe and the content of the second keyframe; and
determining where to display the first keyframe and second keyframe relative to each other along the second axis based on the image similarity relation.

8. The computer-implemented method of claim 6 further comprising:
causing the first keyframe and the second keyframe to be displayed on a display;
identifying if the first keyframe and the second keyframe are overlapping on the display;
displaying the first keyframe transparently so that the second keyframe is at least partially visible.

9. The computer-implemented method of claim 8 further comprising:
receiving user input defining a level of transparency;
applying this level of transparency to the first keyframe.

10. The computer-implemented method of claim 1 further comprising:
causing the keyframe to be displayed on a display;
receiving user input causing a cursor to be positioned within the boundary of the keyframe;
in response to the user input, enlarging the display of the keyframe.

11. The computer-implemented method of claim 1 wherein the first axis is horizontal and the second axis is vertical.

12. The computer-implemented method of claim 1 wherein the first axis is vertical and the second axis is horizontal.

13. The computer-implemented method of claim 1 wherein the first axis and the second axis are disposed to each other at an angle other than ninety degrees.

14. A computer-readable medium carrying one or more sequences of instructions which, when executed by one or more processors, causes the one or more processors to perform the steps of:
receiving input comprising a keyframe from video data;
determining where to display the keyframe along a first axis based on a time associated with the keyframe; and
determining where to display the keyframe along a second axis based on the content of the keyframe.

15. A computer-readable medium carrying one or more sequences of instructions which, when executed by one or more processors, causes the one or more processors to perform the method recited in claim 2.

16. A computer-readable medium carrying one or more sequences of instructions which, when executed by one or more processors, causes the one or more processors to perform the method recited in claim 3.

17. A computer-readable medium carrying one or more sequences of instructions which, when executed by one or more processors, causes the one or more processors to perform the method recited in claim 4.

18. A computer-readable medium carrying one or more sequences of instructions which, when executed by one or more processors, causes the one or more processors to perform the method recited in claim 5.

19. A computer-readable medium carrying one or more sequences of instructions which, when executed by one or more processors, causes the one or more processors to perform the method recited in claim 6.

20. A computer-readable medium carrying one or more sequences of instructions which, when executed by one or more processors, causes the one or more processors to perform the method recited in claim 7.

21. A computer-readable medium carrying one or more sequences of instructions which, when executed by one or more processors, causes the one or more processors to perform the method recited in claim 8.

22. A computer-readable medium carrying one or more sequences of instructions which, when executed by one or more processors, causes the one or more processors to perform the method recited in claim 9.

23. A computer-readable medium carrying one or more sequences of instructions which, when executed by one or more processors, causes the one or more processors to perform the method recited in claim 10.

24. A computer-readable medium carrying one or more sequences of instructions which, when executed by one or more processors, causes the one or more processors to perform the method recited in claim 11.

25. A computer-readable medium carrying one or more sequences of instructions which, when executed by one or more processors, causes the one or more processors to perform the method recited in claim 12.

26. A computer-readable medium carrying one or more sequences of instructions which, when executed by one or more processors, causes the one or more processors to perform the method recited in claim 13.

27. A method comprising performing a machine-executed operation involving instructions, wherein the machine-executed operation is at least one of:
A) sending the instructions over transmission media;
B) receiving the instructions over transmission media;
C) storing the instructions onto a machine-readable storage medium; and
D) executing the instructions;
wherein the instructions are instructions which, when executed by one or more processors, cause the one or more processors to perform steps comprising:
causing video data to be segmented into two or more shots;
generating at least one keyframe from each shot;
automatically determining a temporal relation between each keyframe based on a relative time comparison between each keyframe and an image similarity relation between each keyframe based on the content of the keyframes;
causing the keyframes to be automatically displayed on a display, wherein the keyframes are displayed relative to each other along a first axis based on the temporal relation and along a second axis based on the image similarity relation.

28. The method of claim 27 wherein the first axis is horizontal and the second axis is vertical, and further comprising:
automatically determining a quality rating for each keyframe, wherein the quality rating is based on a weighted sum of human faces present in the keyframe and color histogram entropy of the keyframe; and
causing a first keyframe with a higher quality rating than a second keyframe to be displayed higher along the vertical axis than the second keyframe

29. The method of claim 27 wherein the step of automatically determining an image similarity relation between each keyframe comprises comparing numerical values assigned to each keyframe, wherein the numerical values represent characteristics of each keyframe.

30. The method of claim 27 wherein the step of causing video data to be segmented into two or more shots comprises using an accumulated luminosity histogram difference to detect shot changes and segmenting the video data based upon the detected shot changes

31. The method of claim 27 wherein the step of causing video data to be segmented into two or more shots comprises receiving user input that indicates a frame of the video data as comprising a new shot, and segmenting the video data based upon the user input

32. The method of claim 27 further comprising displaying the keyframes along a third axis.

33. The method of claim 27 further comprising:
receiving user input causing a cursor to be positioned within the boundary of one of the keyframes;
in response to the user input, temporarily repositioning the display of keyframes adjacent to the one keyframe.
